(19) United States
(12) Patent Application Publication
(10) Pub. No.: US 2021/0328357 A1
(43) Pub. Date: Oct. 21, 2021

(54) Antenna, Microwave Device, And Communications System

(71) Applicant: HUAWEI TECHNOLOGIES CO., LTD., Shenzhen (CN)

(72) Inventors: Ning YANG, Chengdu (CN); Jiantao MA, Chengdu (CN)

(21) Appl. No.: 17/360,780

(22) Filed: Jun. 28, 2021

Related U.S. Application Data
(63) Continuation of application No. PCT/CN2018/124661, filed on Dec. 28, 2018.

(51) Int. Cl. H01Q 17/00; H01Q 1/42

(52) U.S. Cl. CPC H01Q 17/008; H01Q 1/42

(57) ABSTRACT

Embodiments of the present disclosure provide example antennas, example microwave devices, and example communications systems. One example antenna includes an antenna body and a filter component. The antenna body includes an antenna aperture and an optical axis. The antenna body is configured to send and receive a radio frequency signal that passes through the antenna aperture. The filter component is located at the antenna aperture and is disposed perpendicular to the optical axis, where the filter component is configured to filter an interference signal in the radio frequency signal. The filter component includes a filter layer and a support component, where the filter layer is formed by a lossy dielectric, where the support component is configured to support the filter layer, and where the filter layer forms a spatial structure similar to a shutter.

### CROSS-REFERENCE TO RELATED APPLICATIONS

This application is a continuation of International Application No. PCT/CN2018/124661, filed on Dec. 28, 2018, the disclosure of which is hereby incorporated by reference in its entirely.

### TECHNICAL FIELD

This application relates to the communications field and, in particular, to an antenna, a microwave device, and a communications system.

### BACKGROUND

With development of communications network technologies, data traffic increases, and deployment costs of base station sites become higher. Therefore, spectral efficiency of an existing site needs to be fully utilized. Microwave backhaul is one of mobile backhaul solutions due to fast deployment and flexible installation features of the microwave backhaul. With continuous increasing of density of base stations, co-channel interference generated by different microwave devices operating in a same frequency band may severely limit improvement of spectral efficiency. Therefore, suppression of co-channel interference signals becomes one of urgent key problems that need to be resolved for the microwave devices.

In a conventional technology, a transmit end suppresses downlink interference by precoding a transmit signal, and a receive end suppresses uplink interference by using a digital baseband interference cancellation algorithm. Both the transmit end and the receive end affect a target service signal. In addition, because the transmit end needs to perform precoding based on channel information fed back by the receive end, and devices of different providers cannot communicate with each other currently, this solution is used only between sending and receiving devices of a same provider, and an application scenario is limited.

### SUMMARY

In view of this, this application provides an antenna, a microwave device in which the antenna is used, and a communications system, to resolve a problem that an interference suppression process affects a target service signal and a problem that a scenario is limited.

According to a first aspect, this application provides an antenna, including an antenna body and a filter component. The antenna body has an antenna aperture and is configured to send and receive a radio frequency signal (for example, a microwave signal) that passes through the antenna aperture, and the antenna body has an optical axis. The filter component is located at the antenna aperture and is disposed perpendicular to the optical axis (where it should be understood that “perpendicular” may be substantially perpendicular), and is configured to filter an interference signal in the radio frequency signal. The filter component may include a filter layer and a support component. The filter layer is formed by a lossy dielectric. The support component is configured to support the filter layer so that the filter layer forms a spatial structure similar to a shutter. In this embodiment of the present disclosure, the filter component having a shutter structure can be used to suppress a combined electric intensity in a non-zero angle range, thereby implementing antenna sidelobe suppression and reducing impact of the interference signal on a received target service signal. Implementation complexity of the antenna is low, the target service signal is almost not affected, and an application scenario is not limited (where for example, sending and receiving devices are not limited to being from a same provider).

In a possible implementation, the filter layer includes a plurality of equally spaced concentric circles, a spacing between any two adjacent concentric circles is greater than and is a wavelength corresponding to a minimum operating frequency of the radio frequency signal. The plurality of equally spaced concentric circles may be used to implement an electromagnetic shutter structure and antenna sidelobe suppression.

In a possible implementation, the filter layer includes a plurality of semicircles with progressively increasing radii, two adjacent semicircles are connected head to tail, a spacing between any two adjacent semicircles is greater than λ/4, and λ is a wavelength corresponding to a minimum operating frequency of the radio frequency signal. The plurality of semicircles with progressively increasing radii may be used to implement an electromagnetic shutter structure and antenna sidelobe suppression.

In a possible implementation, the filter layer includes at least one Archimedes spiral, a spiral spacing is greater than λ/4, and λ is a wavelength corresponding to a minimum operating frequency of the radio frequency signal. The Archimedes spiral may be used to implement an electromagnetic shutter structure and antenna sidelobe suppression.

In a possible implementation, the antenna further includes a radome, and the filter layer is attached to an aperture of the radome. The filter layer may be attached to an inner side of the aperture of the radome and is protected by the radome, thereby avoiding impact of an environment.

In a possible implementation, the support component includes a base plate and a support frame, and the support frame matches the filter layer. A filter layer with a relatively soft material is supported by a support frame with a matching size so that the filter layer forms an electromagnetic shutter structure, thereby implementing antenna sidelobe suppression and reducing impact of the interference signal.

In a possible implementation, the base plate may be a round plate or a cross.

According to a second aspect, this application provides a microwave device. The microwave device includes an antenna, an indoor unit, and an outdoor unit, and the antenna includes an antenna body and a filter component. The antenna body has an antenna aperture and is configured to send and receive a radio frequency signal (for example, a microwave signal) that passes through the antenna aperture, and the antenna body has an optical axis. The filter component is located at the antenna aperture and is disposed perpendicular to the optical axis (where it should be understood that “perpendicular” may be substantially perpendicular) and is configured to filter an interference signal in the radio frequency signal. The filter component may include a filter layer and a support component. The filter layer is formed by a lossy dielectric. The support component is configured to support the filter layer so that the filter layer forms a spatial structure similar to a shutter. In this embodiment of the present disclosure, the filter component having a shutter structure can be used to suppress a combined electric intensity in a non-zero angle range, thereby implementing antenna sidelobe suppression and reducing impact of an interference signal on a received target service signal. Implementation complexity of the antenna is low, the target service signal is almost not affected, and an application scenario is not limited (where for example, sending and receiving devices are not limited to being from a same provider).

In a possible implementation, the filter layer includes a plurality of equally spaced concentric circles, a spacing between any two adjacent concentric circles is greater than λ/4, and λ is a wavelength corresponding to a minimum operating frequency of the radio frequency signal. The plurality of equally spaced concentric circles may be used to implement an electromagnetic shutter structure and antenna sidelobe suppression.

In a possible implementation, the filter layer includes a plurality of semicircles with progressively increasing radii, two adjacent semicircles are connected head to tail, a spacing between any two adjacent semicircles is greater than λ/4, and is a wavelength corresponding to a minimum operating frequency of the radio frequency signal. The plurality of semicircles with progressively increasing radii may be used to implement an electromagnetic shutter structure and antenna sidelobe suppression.

In a possible implementation, the filter layer includes at least one Archimedes spiral, a spiral spacing is greater than λ/4, and is a wavelength corresponding to a minimum operating frequency of the radio frequency signal. The Archimedes spiral may be used to implement an electromagnetic shutter structure and antenna sidelobe suppression.

In a possible implementation, the antenna further includes a radome, and the filter layer is attached to an aperture of the radome. The filter layer may be attached to an inner side of the aperture of the radome, and is protected by the radome, thereby avoiding impact of an environment.

In a possible implementation, the support component includes a base plate and a support frame, and the support frame matches the filter layer. A filter layer with a relatively soft material is supported by a support frame with a matching size so that the filter layer forms an electromagnetic shutter structure, thereby implementing antenna sidelobe suppression, and reducing impact of an interference signal.

In a possible implementation, the base plate may be a round plate or a cross.

According to a third aspect, this application provides a communications system. The communications system includes at least two microwave devices according to the second aspect or any possible implementation of the second aspect.

### BRIEF DESCRIPTION OF DRAWINGS

To describe the technical solutions in some of the embodiments of the present disclosure, the following briefly describes the accompanying drawings used to describe the embodiments.

FIG. 1 is a schematic diagram of a microwave network architecture according to an embodiment of the present disclosure;

FIG. 2A is a schematic structural diagram of an antenna according to an embodiment of the present disclosure;

FIG. 2B is a schematic structural diagram of an antenna according to an embodiment of the present disclosure;

FIG. 3A is a schematic structural diagram of an electromagnetic shutter according to an embodiment of the present disclosure;

FIG. 3B is a schematic structural diagram of a support component according to an embodiment of the present disclosure;

FIG. 3C is a schematic structural diagram of another support component according to an embodiment of the present disclosure;

FIG. 4A is a schematic structural diagram of an electromagnetic shutter according to an embodiment of the present disclosure;

FIG. 4B is a schematic structural diagram of a support component according to an embodiment of the present disclosure;

FIG. 4C is a schematic structural diagram of another support component according to an embodiment of the present disclosure;

FIG. 5A is a schematic structural diagram of an electromagnetic shutter according to an embodiment of the present disclosure;

FIG. 5B is a schematic structural diagram of a support component according to an embodiment of the present disclosure;

FIG. 5C is a schematic structural diagram of a support component according to an embodiment of the present disclosure;

FIG. 6A is a schematic structural diagram of an electromagnetic shutter according to an embodiment of the present disclosure;

FIG. 6B is a schematic structural diagram of a support component according to an embodiment of the present disclosure;

FIG. 6C is a schematic structural diagram of a support component according to an embodiment of the present disclosure;

FIG. 7 is a schematic structural diagram of a microwave device according to an embodiment of the present disclosure.

FIG. 8 is a schematic diagram of a network architecture of an application scenario according to an embodiment of the present disclosure; and

FIG. 9 is a comparison diagram of antenna directivity according to an embodiment of the present disclosure.

### DESCRIPTION OF EMBODIMENTS

The present disclosure is further described below in detail with reference to the accompanying drawings and embodiments.

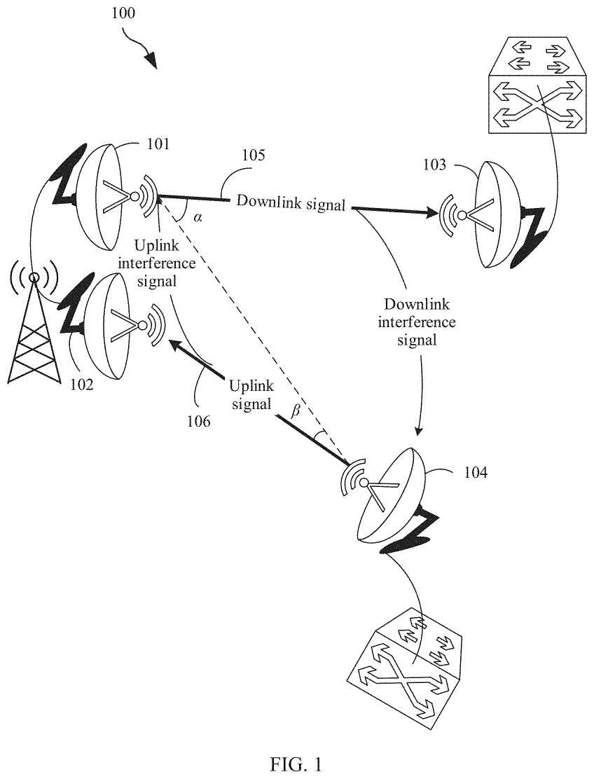

A possible application scenario of the embodiments of the present disclosure is first described. FIG. 1 is a schematic diagram of a microwave network architecture according to an embodiment of the present disclosure. As shown in FIG. 1, a microwave network system 100 may include two or more microwave devices and a microwave link between any two microwave devices. The microwave devices may send and receive signals by using antennas. For example, four antennas 101 to 104 are shown in the figure. The antenna 101 and the antenna 102 may belong to a same microwave device, or may belong to different microwave devices. The microwave network system 100 may be used for backhaul or fronthaul of a wireless signal, and microwave devices to which the antenna 101 and the antenna 102 belong may be connected to a base station. When a microwave device of the antenna 101 serves as a transmit end, the antenna 101 sends a downlink signal to the antenna 103 by using a microwave link 105. If a relative angle α between a downlink signal direction of the antenna 101 and the antenna 104 is less than 90 degrees, and the antenna 104 and the antenna 101 operate in a same frequency band, a downlink signal sent by the antenna 101 to the antenna 103 generates a downlink interference signal to the antenna 104. The antenna 103 and the antenna 104 may belong to a same microwave device, or may belong to different microwave devices. Microwave devices to which the antenna 103 and the antenna 104 belong may be connected to a base station controller, or may be connected to a transport device, such as an optical network device or an Ethernet device. When a microwave device of the antenna 102 serves as a receive end, the antenna 102 receives an uplink signal from the antenna 104 by using a microwave link 106. If a relative angle β between an uplink signal direction of the antenna 104 and the antenna 101 is less than 90 degrees, and the antenna 101 and the antenna 104 operate in a same frequency band, an uplink signal sent by the antenna 104 to the antenna 102 generates an uplink interference signal to the antenna 101.

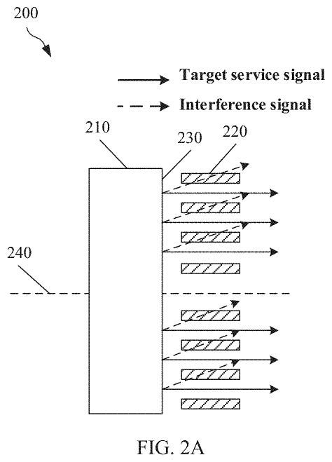

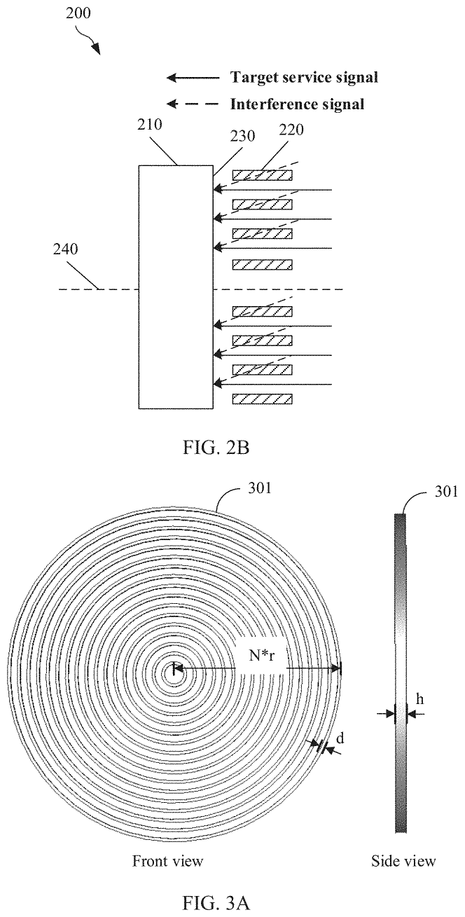

An embodiment of the present disclosure provides an antenna, which may be applied to a microwave device to improve an anti-interference capability of the microwave device. FIG. 2A is a schematic structural diagram of an antenna according to an embodiment of the present disclosure. As shown in FIG. 2A, the antenna 200 may include an antenna body 210 and a filter component 220. The antenna body 210 has an antenna aperture 230 and is configured to send and receive an electromagnetic wave signal, such as a radio frequency signal or a microwave signal, that passes through the antenna aperture 230. The antenna body 210 may be an antenna having any structure in the prior art, for example, a Cassegrain antenna, a parabolic antenna, or a lens antenna, or may be an antenna of any structure that may appear in the future. The antenna aperture 230 is actually an equivalent face of a front end of the antenna. For example, in a parabolic antenna, an antenna aperture may be a circular face formed by a front end of a reflective surface. The antenna aperture (or an effective area) is a parameter indicating efficiency of receiving electromagnetic wave power by an antenna. The antenna aperture is perpendicular to directions of incident electromagnetic waves, and an area within which energy of the incident radio waves is effectively intercepted. The antenna body 210 may include a series of optical elements. For example, a Cassegrain antenna may include a feed, a primary reflective surface, and a secondary reflective surface. A parabolic antenna may include a feed and a reflective surface. A lens antenna may include a feed and a lens. The antenna body 210 may be an optical system and has an optical axis 240, and the optical axis 240 is an imaginary line in the optical system and defines how the optical system conducts a light ray. The filter component 220 is located near the antenna aperture 230, and may be located exactly at a position of the antenna aperture 230, or may deviate from the position of the antenna aperture 230 within a specific range. Optionally, the antenna 200 may further include a radome (not shown in the figure), configured to protect the antenna from interference from an external environment. Alternatively, the filter component 220 may be attached to an aperture of the radome, or may be integrally formed with the radome, or may be used as an independent component. The filter component 220 includes a filter layer and a support component, and the filter layer is formed by a lossy dielectric. The lossy dielectric is usually a material that has a large loss of an electromagnetic wave, for example, a wave-absorbing material. Because a material of the lossy dielectric is relatively soft, a support component is required to support the lossy dielectric so that the filter layer forms a spatial structure similar to a shutter to filter an interference signal. The support component may use a material with good wave-transparent performance, such as ABS plastics or glass reinforced plastics. The antenna 200 may be applied to a transmit end device. An interference signal is absorbed after passing through the filter component 220, and a target service signal may be directly transmitted through the filter component 220. The filter component haying a shutter structure is used to suppress a combined electric intensity in a non-zero angle range, thereby implementing antenna sidelobe suppression, and implementing interference signal suppression.

The antenna 200 may alternatively be applied to a receive end device. FIG. 2B is a schematic structural diagram of an antenna according to an embodiment of the present disclosure. As shown in FIG. 2B, transmission directions of a target service signal and an interference signal are opposite to those in FIG. 2A. The interference signal in this embodiment of the present disclosure may be a co-channel interference signal, or may be a non-co-channel interference signal.

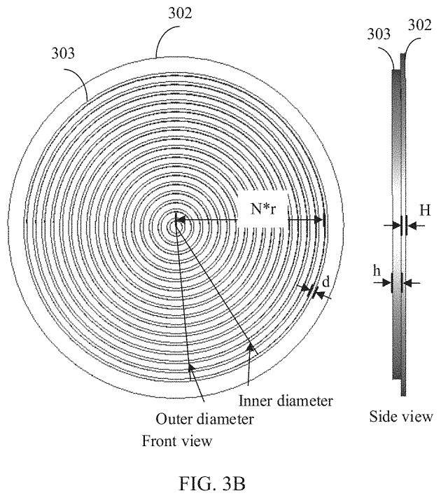

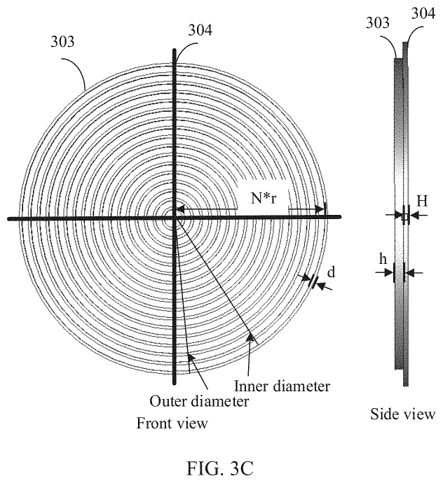

The filter layer may implement an electromagnetic shutter structure in a plurality of manners. FIG. 3A is a schematic structural diagram of an electromagnetic shutter according to an embodiment of the present disclosure. As shown in FIG. 3A, it can be learned from a front view that the electromagnetic shutter may include a plurality of equally spaced concentric circles 301. In a direction from a center of a circle to the outside, a radius of a first concentric circle 301 is r, a radius of a second concentric circle 301 is 2×r, and a radius of an Nth concentric circle 301 is N×r. In addition, the radius r and a quantity N of the concentric circle 301 need to be designed based on an antenna aperture, in other words, N×r=R, where R is a radius of the antenna aperture. Certainly, N×r may alternatively be slightly less than R. In addition, a spacing r between two adjacent concentric circles 301 is greater than λ/4, where λ is a wavelength corresponding to a minimum operating frequency of an electromagnetic wave. It can be learned from a side view that a height of a concentric circle 301 is h, and the height h and a thickness d of each concentric circle 301 are as much as possible the same. Usually, a larger height h leads to a larger thickness d and a better sidelobe suppression effect, but a larger antenna gain loss, and the two indexes of the sidelobe suppression effect and the antenna gain loss need to be comprehensively considered to determine the height h and the thickness d of the concentric circle 301.

FIG. 3B is a schematic structural diagram of a support component according to an embodiment of the present disclosure, where the support component may be configured to support the electromagnetic shutter structure shown in FIG. 3A. As shown in FIG. 3B, the support component may include a base plate 302 and a plurality of equally spaced concentric circles 303 (support frame). A radius of a concentric circle 303 matches the radius of the concentric circle 301 of the electromagnetic shutter, and the concentric circle 301 covers the inner diameter side (or outer diameter side) of the concentric circle 303. If the concentric circle 301 covers the inner diameter side of the concentric circle 303, an outer diameter of the concentric circle 301 is the same as an inner diameter of the concentric circle 303. If the concentric circle 301 covers the outer diameter side of the concentric circle 303, an inner diameter of the concentric circle 301 is the same as an outer diameter of the concentric circle 303. A quantity of concentric circles 303 and a quantity of concentric circles 301 may be the same, and the height h of the concentric circle 303 and the height h of the concentric circle 301 may be the same. A height H of the base plate 302 and a thickness d of the concentric circle 303 are as small as possible, thereby reducing reflection of electromagnetic waves.

FIG. 3C is a schematic structural diagram of another support component according to an embodiment of the present disclosure, where the support component may also be configured to support the electromagnetic shutter structure shown in FIG. 3A. FIG. 3C differs from FIG. 3B in that the base plate 302 may be replaced with a cross 304. The cross 304 may be implemented using the same material as the base plate 302.

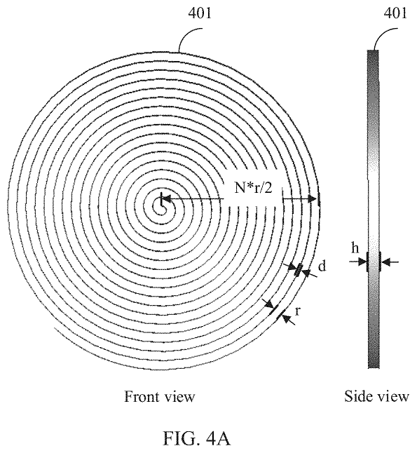

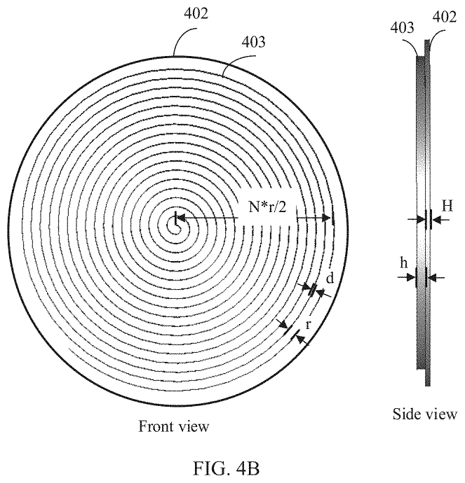

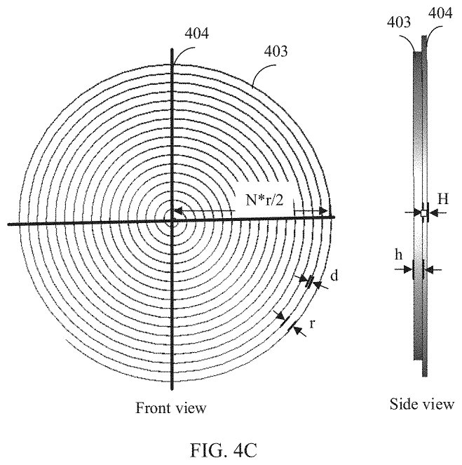

FIG. 4A is a schematic structural diagram of an electromagnetic shutter according to an embodiment of the present disclosure. As shown in FIG. 4A, from a front view, the electromagnetic shutter may include a plurality of semicircles 401 with progressively increasing radii, and two adjacent semicircles are alternately connected head to tail. In a direction from a center of a circle to the outside, a radius of a first semicircle 401 is r/2, a radius of a second semicircle 401 is r, and a radius of an Nth semicircle 401 is N×r/2. The radius r and a quantity N of the semicircle 401 need to be designed based on an antenna aperture. In other words, N×r/2≤R, where R is a radius of the antenna aperture. In addition, a spacing r between two adjacent semicircles 401 is greater than λ/4, where λ is a wavelength corresponding to a minimum operating frequency of an electromagnetic wave. It can be learned from a side view that a height of a semicircle 401 is h, and the height h and a thickness d of each semicircle 401 are as much as possible the same. Usually, a larger height h leads to a larger thickness d and a better sidelobe suppression effect, but a larger antenna gain loss, and the two indexes of the sidelobe suppression effect and the antenna gain loss need to be comprehensively considered to determine the height h and the thickness d of the semicircle 401.

FIG. 4B is a schematic structural diagram of a support component according to an embodiment of the present disclosure, where the support component is configured to support the shutter structure shown in FIG. 4A. As shown in FIG. 4B, the support component may include a. base plate 402 and a plurality of semicircles 403 (support frame) with progressively increasing radii. The base plate 402 is similar to the base plate 302. A radius of a semicircle 403 matches the radius of the semicircle 401, and the semicircle 403 covers the inner diameter side (or outer diameter side) of the semicircle 401, If the semicircle 401 covers the inner diameter side of the semicircle 403, an outer diameter of the semicircle 401 is the same as an inner diameter of the semicircle 403. If the semicircle 401 covers the outer diameter side of the semicircle 403, an inner diameter of the semicircle 401 is the same as an outer diameter of the semicircle 403. A quantity of semicircles 403 and a quantity of semicircles 401 may be the same, and the height h of the semicircle 403 and the height h of the semicircle 401 may be the same. A height H of the base plate 402 and a thickness d of the semicircle 403 are as small as possible, thereby reducing reflection of electromagnetic waves.

FIG. 4C is a schematic structural diagram of another support component according to an embodiment of the present disclosure, where the support component may also be configured to support the shutter structure shown in FIG. 4A. FIG. 4C differs from FIG. 4B in that the base plate 402 may be replaced with a cross 404. The cross 404 may be implemented using the same material as the base plate 402.

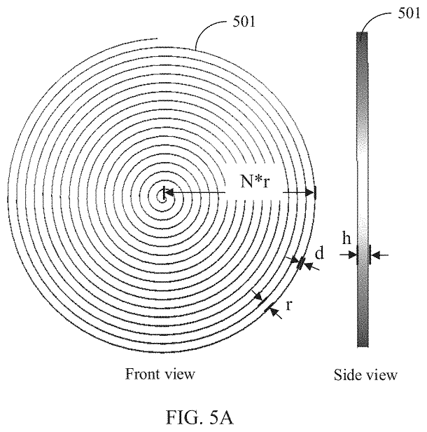

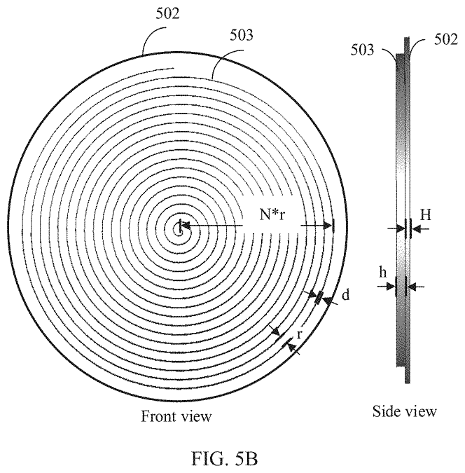

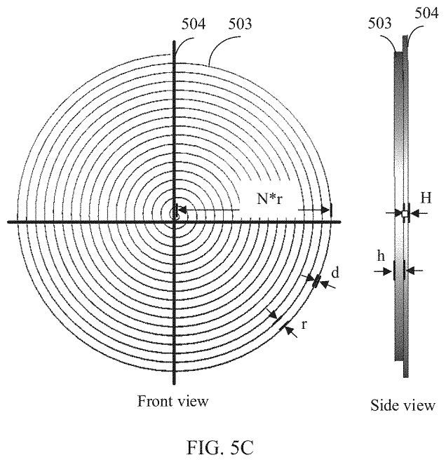

FIG. 5A is a schematic structural diagram of an electromagnetic shutter according to an embodiment of the present disclosure. As shown in FIG. 5A, it can be learned from a front view, the electromagnetic shutter may include an Archimedes spiral 501. A spiral spacing is r, and the spiral spacing r and a quantity N of turns need to be designed based on an antenna aperture, in other words, N×r≤R, where R is a radius of the antenna aperture. In addition, the spiral spacing r is greater than λ/4, where λ is a wavelength corresponding to a minimum operating frequency of an electromagnetic wave. It can be learned from a side view that a height of the Archimedes spiral 501 is h, and a height h and a thickness d of each turn are as much as possible the same. Usually, a larger height h leads to a larger thickness d and a better sidelobe suppression effect, but a larger antenna gain loss, and the two indexes of the sidelobe suppression effect and the antenna gain loss need to be comprehensively considered to determine the height h and the thickness d of the Archimedes spiral 501.

FIG. 5B is a schematic structural diagram of a support component according to an embodiment of the present disclosure, where the support component may be configured to support the electromagnetic shutter structure shown in FIG. 5A, As shown in FIG. 5B, the support component may include a base plate 502 and an Archimedes spiral 503 (support frame). A size of the Archimedes spiral 503 matches a size of the Archimedes spiral 501 of the electromagnetic shutter, and the Archimedes spiral 501 covers the inner diameter side (or outer diameter side) of the Archimedes spiral 503. If the Archimedes spiral 501 covers the inner diameter side of the Archimedes spiral 503, an outer diameter of the Archimedes spiral 501 is the same as an inner diameter of the Archimedes spiral 503. If the Archimedes spiral 501 covers the outer diameter side of the Archimedes spiral 503, an inner diameter of the Archimedes spiral 501 is the same as an outer diameter of the Archimedes spiral 503. A quantity of turns of the Archimedes spiral 503 and a quantity of turns of the Archimedes spiral 501 may be the same, and a height h of the Archimedes spiral 503 and the height h of the Archimedes spiral 501 may be the same. A height H of the base plate 502 and a thickness d of the Archimedes spiral 503 are as small as possible, thereby reducing reflection of electromagnetic waves.

FIG. 5C is a schematic structural diagram of a support component according to an embodiment of the present disclosure, where the support component may be configured to support the electromagnetic shutter structure shown in FIG. 5A, FIG. 5C differs from FIG. 5B in that the base plate 502 may be replaced with a cross 504. The cross 504 may be implemented using the same material as the base plate 502.

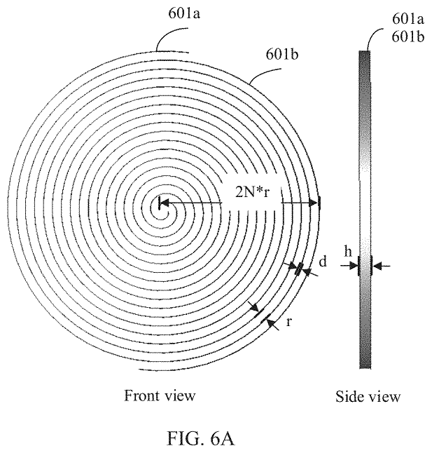

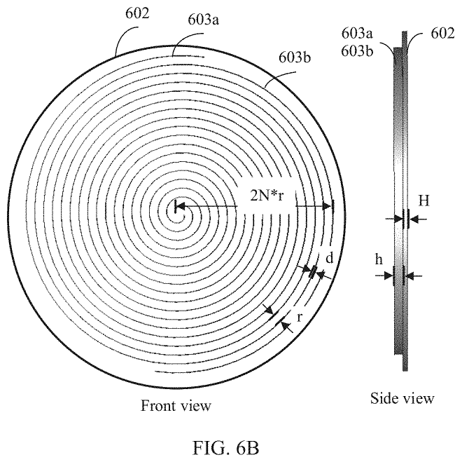

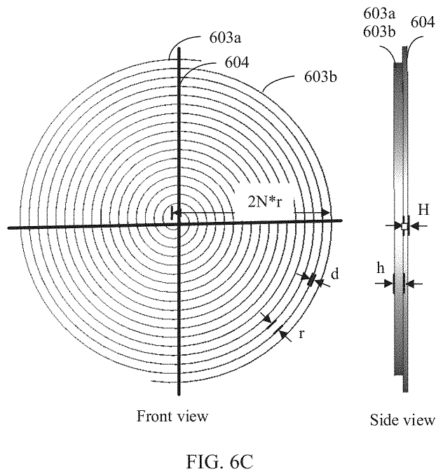

FIG. 6A is a schematic structural diagram of an electromagnetic shutter according to an embodiment of the present disclosure. As shown in FIG. 6A, it can be learned from a front view that the electromagnetic shutter may include two Archimedes spirals 601a and 601b that are alternated with each other. A spacing of a single spiral is 2×r. A spacing obtained after two spirals are alternated with each other is r and a quantity N of turns of each spiral is designed based on an antenna aperture, in other words, 2N×r≤R, where R is a radius of the antenna aperture. In addition, a spiral spacing r obtained after alternating is greater than λ/4, where λ is a wavelength corresponding to a minimum operating frequency of an electromagnetic wave. It can be learned from a side view that a height of each of the Archimedes spirals 601a and 601b is h, and a height h and a thickness d of each turn are as much as possible the same. Usually, a larger height h leads to a larger thickness d and a better sidelobe suppression effect, but a larger antenna gain loss, and the two indexes of the sidelobe suppression effect and the antenna gain loss need to be comprehensively considered to determine the height h and the thickness d of the Archimedes spiral 501.

FIG. 6B is a schematic structural diagram of a support component according to an embodiment of the present disclosure, where the support component may be configured to support the electromagnetic shutter structure shown in FIG. 6A. As shown in FIG. 6B, the support component may include a base plate 602 and two Archimedes spirals 603a and 603b (support frame). A size of each of the Archimedes spirals 603a and 603b matches a size of each of the Archimedes spirals 601a and 601b of the electromagnetic shutter, and each of the Archimedes spirals 601a and 601b covers the inner diameter side (or outer diameter side) of each of the Archimedes spirals 603a and 603b. If each of the Archimedes spirals 601a and 601b covers the inner diameter side of each of the Archimedes spirals 603a and 603b, an outer diameter of each of the Archimedes spirals 601a and 601b is the same as an inner diameter of each of the Archimedes spirals 603a and 603b. If each of the Archimedes spirals 601a and 601b covers the outer diameter side of each of the Archimedes spirals 603a and 603b, an inner diameter of each of the Archimedes spirals 601a and 601b is the same as an outer diameter of each of the Archimedes spirals 603a and 603b. A quantity of turns of each of the Archimedes spirals 603a and 603band a quantity of turns of each of the Archimedes spirals 601a and 601b may be the same, and a height h of each of the Archimedes spirals 603a and 603b and a height h of each of the Archimedes spirals 601a and 601b may be the same. A height Ii of the base plate 602 and a thickness d of each of the Archimedes spirals 603a and 603b are as small as possible, thereby reducing reflection of electromagnetic waves.

FIG. 6C is a schematic structural diagram of a support component according to an embodiment of the present disclosure, where the support component may be configured to support the electromagnetic shutter structure shown in FIG. 6A. FIG. 6C differs from FIG. 6B in that the base plate 602 may be replaced with a cross 604. The cross 604 may be implemented using the same material as the base plate 602.

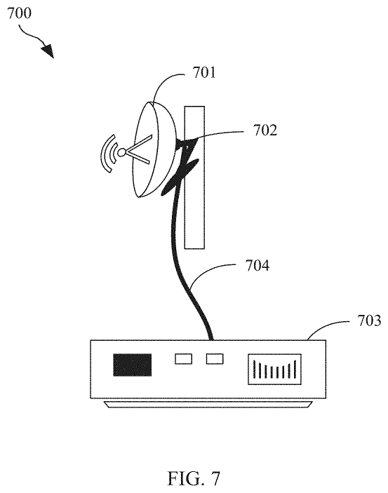

FIG. 7 is a schematic structural diagram of a microwave device according to an embodiment of the present disclosure. As shown in FIG. 7, the microwave device 700 may include an antenna 701, an outdoor unit (ODU) 702, an indoor unit (IDU) 703, and an intermediate frequency cable 704. The microwave device 700 may include one or more antennas 701. The ODU 702 and the IDU 703 may be connected by using the intermediate frequency cable 704, and the ODU 702 and the antenna 701 may be connected by using a feed waveguide.

The antenna 701 may be implemented by using any antenna in the foregoing embodiments, and includes an antenna body and a filter component. The antenna 701 mainly provides a directional sending and receiving function of a radio frequency signal, and implements conversion between a radio frequency signal generated or received by the ODU 702 and a radio frequency signal in atmospheric space. In a transmit direction, the antenna 701 converts a radio frequency signal output by the ODU 702 into a radio frequency signal with directivity, and radiates the radio frequency signal into space. In a receive direction, the antenna 701 receives a radio frequency signal in the space, focuses the radio frequency signal, and transmits the radio frequency signal to the ODU 702. The antenna provided in this embodiment of the present disclosure may be an antenna in the transmit direction, or may be an antenna in the receive direction.

For example, in the receive direction, the antenna 701 receives a spatially radiated radio frequency signal, where the radio frequency signal includes a target service signal and an interference signal, and filters the interference signal by using the filter component. The filter component includes a filter layer and a support component, and the filter layer is formed by a lossy dielectric. The support component is configured to support the filter layer so that the filter layer forms a spatial structure similar to a shutter. The antenna 701 receives the radio frequency signal filtered by using the filter component and then sends the radio frequency signal to the ODU 702.

In the transmit direction, the antenna 701 receives a radio frequency signal from the ODU 702, where the radio frequency signal includes a target service signal and an interference signal, and filters the interference signal by using the filter component. The antenna 701 sends the radio frequency signal filtered by using the filter component.

The ODU 702 may include an intermediate frequency module, a sending module, a receiving module, a multiplexer, a duplexer, and the like. The ODU 702 mainly provides a function of mutual conversion between an intermediate frequency analog signal and a radio frequency signal. In the transmit direction, the ODU 702 performs up-conversion and amplification on an intermediate frequency analog signal from the IDU 703, to convert the intermediate frequency analog signal into a radio frequency signal with a specific frequency, and sends the radio frequency signal to the antenna 701. In the receive direction, the ODU 702 performs down-conversion and amplification on a radio frequency signal received from the antenna 701, to convert the radio frequency signal into an intermediate frequency analog signal, and sends the intermediate frequency analog signal to the IDU 703.

The IDU 703 may include a board type such as a main control, switching, and timing board, an intermediate frequency board, and a service board, and may provide a plurality of service interfaces such as a gigabit Ethernet (GE) service, a synchronous transfer mode-1 (STM-1) service, and an E1 service. The IDU 703 provides a function of baseband processing of a service signal and mutual conversion between a baseband signal and an intermediate frequency analog signal. In the transmit direction, the IDU 703 modulates a baseband digital signal into an intermediate frequency analog signal. In the receive direction, the IDU 703 demodulates and digitizes a received intermediate frequency analog signal, to decompose the received intermediate frequency analog signal into a baseband digital signal.

The microwave device 700 may be a separate microwave device, in other words, the IDU 703 is placed indoors, and the ODU 702 and the antenna 701 are assembled and placed outdoors. Alternatively, the microwave device 700 may alternatively be an all-outdoor microwave device, in other words, the ODU 702, the IDU 703, and the antenna 701 are all placed outdoors. The microwave device 700 may alternatively be an all-indoor microwave device, in other words, the ODU 702 and the IDU 703 are placed indoors, and the antenna 701 is placed outdoors. The ODU 702 may also be referred to as a radio frequency module, and the IDU 703 may also be referred to as a baseband.

The antenna provided in this embodiment of the present disclosure is applied to the microwave device, and the filter component having a shutter structure can be used to suppress a combined electric intensity in a non-zero angle range, thereby implementing antenna sidelobe suppression and improving an anti-interference capability of the device on the premise that a target service signal is almost not affected.

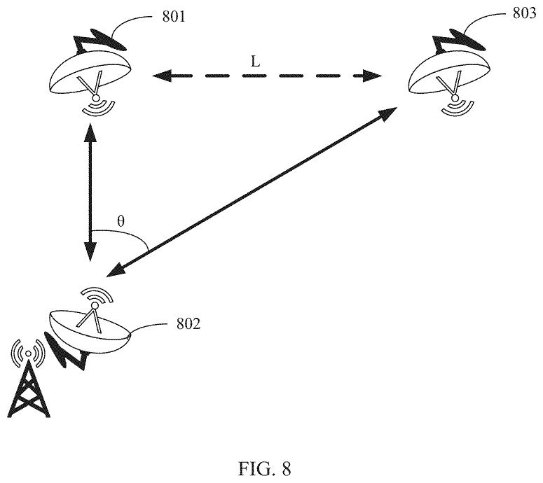

FIG. 8 is a schematic diagram of a network architecture of an application scenario according to an embodiment of the present disclosure. As shown in FIG. 8, for a co-frequency and co-polarized (V-polarized) network scenario, a network device 801 properly communicates with a network device 802, and an interference source 803 has a lateral offset distance L relative to the network device 801, where the lateral offset distance is equivalent to a lateral offset angle θ. After the technical solution provided in this embodiment of the present disclosure is used, an interference signal whose θ is greater than 5 degrees is obviously suppressed.

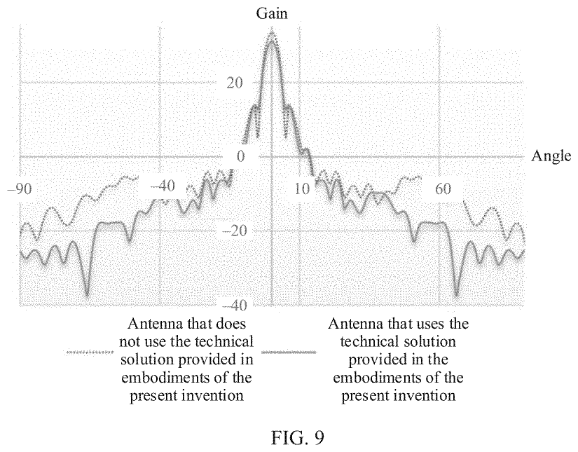

FIG. 9 is a comparison diagram of antenna directivity according to an embodiment of the present disclosure. It can be learned from FIG. 9 that a solid line represents a directivity pattern of an antenna that uses the technical solution provided in the embodiments of the present disclosure, and a dashed line represents a directivity pattern of an antenna that does not use the technical solution provided in the embodiments of the present disclosure. It can be learned that, in the directivity pattern of the antenna that uses the technical solution provided in this embodiment of the present disclosure, an antenna sidelobe is suppressed.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An antenna, wherein the antenna comprises:
an antenna body comprising an antenna aperture and an optical axis, and wherein the antenna body is configured to send and receive a radio frequency signal that passes through the antenna aperture; and
a filter component located at the antenna aperture and disposed perpendicular to the optical axis, wherein the filter component is configured to filter an interference signal in the radio frequency signal, wherein the filter component comprises a filter layer and a support component, wherein the filter layer is formed by a lossy dielectric, wherein the support component is configured to support the filter layer, and wherein the filter layer forms a spatial structure similar to a shutter.

2. The antenna according to claim 1, wherein the filter layer comprises a plurality of equally spaced concentric circles, a spacing between any two adjacent concentric circles is greater than λ/4, and λ is a wavelength corresponding to a minimum operating frequency of the radio frequency signal.

3. The antenna according to claim 1, wherein the filter layer comprises a plurality of semicircles with progressively increasing radii, two adjacent semicircles are connected head to tail, a spacing between any two adjacent semicircles is greater than λ/4, and λ is a wavelength corresponding to a minimum operating frequency of the radio frequency signal.

4. The antenna according to claim 1, wherein the filter layer comprises at least one Archimedes spiral, a spiral spacing of the at least one Archimedes spiral is greater than λ/4, and λ is a wavelength corresponding to a minimum operating frequency of the radio frequency signal.

5. The antenna according to claim 1, wherein the antenna further comprises a radome, and wherein the filter layer is attached to an aperture of the radome.

6. The antenna according to claim 1, wherein the support component comprises a base plate and a support frame, and wherein the support frame matches the filter layer.

7. The antenna according to claim 6, wherein the base plate is a round plate or a cross.

8. The antenna according to claim 1, wherein forming the spatial structure similar to the shutter comprises forming a shutter structure.

9. A microwave device, wherein the microwave device comprises an antenna, an indoor unit, and an outdoor unit, and wherein the antenna comprises:
an antenna body comprising an antenna aperture and an optical axis, and wherein the antenna body is configured to send and receive a radio frequency signal that passes through the antenna aperture; and
a filter component located at the antenna aperture and disposed perpendicular to the optical axis, wherein the filter component is configured to filter an interference signal in the radio frequency signal, wherein the filter component comprises a filter layer and a support component, wherein the filter layer is formed by a lossy dielectric, wherein the support component is configured to support the filter layer, wherein the filter layer forms a spatial structure similar to a shutter.

10. The microwave device according to claim 9, wherein the filter layer comprises a plurality of equally spaced concentric circles, a spacing between any two adjacent concentric circles is greater than λ/4, and λ is a wavelength corresponding to a minimum operating frequency of the radio frequency signal.

11. The microwave device according to claim 9, wherein the filter layer comprises a plurality of semicircles with progressively increasing radii, two adjacent semicircles are connected head to tail, a spacing between any two adjacent semicircles is greater than λ/4, and λ is a wavelength of a minimum operating frequency of the radio frequency signal.

12. The microwave device according to claim 9, wherein the filter layer comprises at least one Archimedes spiral, a spiral spacing of the at least one Archimedes spiral is greater than λ/4, and λ is a wavelength corresponding to a minimum operating frequency of the radio frequency signal.

13. The microwave device according to claim 9, wherein the antenna further comprises a radome, and wherein the filter layer is attached to an aperture of the radome.

14. The microwave device according to claim 9, wherein the support component comprises a base plate and a support frame, and wherein the support frame matches the filter layer.

15. The microwave device according to claim 14, wherein the base plate is a round plate or a cross.

16. The microwave device according to claim 9, wherein forming the spatial structure similar to the shutter comprises forming a shutter structure.

17. A communications system, wherein the communications system comprises at least two microwave devices, wherein each microwave device of the at least two microwave devices comprises an antenna, an indoor unit, and an outdoor unit, and wherein the antenna comprises:
an antenna body comprising an antenna aperture and an optical axis, and wherein the antenna body is configured to send and receive a radio frequency signal that passes through the antenna aperture; and
a filter component located at the antenna aperture and disposed perpendicular to the optical axis, wherein the filter component is configured to filter an interference signal in the radio frequency signal, wherein the filter component comprises a filter layer and a support component, wherein the filter layer is firmed by a lossy dielectric, wherein the support component is configured to support the filter layer, wherein the filter layer forms a spatial structure similar to a shutter.

18. The communications system according to claim 17, wherein the filter layer comprises a plurality of equally spaced concentric circles, a spacing between any two adjacent concentric circles is greater than λ/4, and λ is a wavelength corresponding to a minimum operating frequency of the radio frequency signal.

19. The communications system according to claim 17, wherein the filter layer comprises a plurality of semicircles with progressively increasing radii, two adjacent semicircles are connected head to tail, a spacing between any two adjacent semicircles is greater than λ/4, and λ is a wavelength corresponding to a minimum operating frequency of the radio frequency signal.

20. The communications system according to claim 17, wherein the filter layer comprises at least one Archimedes spiral, a spiral spacing of the at least one Archimedes spiral is greater than λ/4, and λ is a wavelength corresponding to a minimum operating frequency of the radio frequency signal.
